(19) United States
(12) Patent Application Publication
(10) Pub. No.: US 2010/0104441 A1
(43) Pub. Date: Apr. 29, 2010

(54) Method and apparatus for vertical-axis turbine

(76) Inventors: Norman Manley, Leander, TX (US); Mark S. Manley, Leander, TX (US)

Correspondence Address: RICK B. YEAGER, ATTORNEY, 10805 MELLOW LANE, AUSTIN, TX, 78759, US

(21) Appl. No.: 12/604,639

(22) Filed: Oct. 23, 2009

Related U.S. Application Data
(60) Provisional application No. 61/108,002, filed on Oct. 23, 2008.

(51) Int. Cl. F03D 3/02

(52) U.S. Cl. 416/200 R

(57) ABSTRACT

A vertical turbine comprising a plurality of fluid capture element layers, where each layer provides a plurality of fluid capture elements. The layers are radially offset, thereby providing a spacing between vertically-adjacent fluid capture elements. This spacing permits fluid to flow around the fluid capture elements that are turning into the direction of fluid flow, thereby reducing back-pressure on the device while maintaining a large fluid capture profile. The turbine provides a low rpm, high-torque power generation device which may be used to generate electricity, or to provide direct applications such as pumping.

This application is related to U.S. Provisional Patent application No. 61/108,002 filed Oct. 23, 2008, and claims the priority of that filing date.

### BACKGROUND

1. Field of Invention

The current invention relates to vertical-axis fluid turbines such as wind turbines or water turbines.

2. Prior Art

Large conventional wind turbines are efficient with respect to the capture of energy from wind, but they have several disadvantages. One disadvantage is that their high tip speed generates high noise. Another disadvantage is that their support structure must be massive enough to support the dynamic load of the turbine blades without the use of guy wires, because wires would interfere with the operation of the blades. Another disadvantage is that this type of device requires a large spacing between units to permit the blades to rotate with respect to wind direction. The devices are not well-suited for urban environments such as building roofs.

Several prior art vertical turbine designs include 2, 3, or 4 solid and tall vertically-oriented wind capture elements mounted on a vertical rotating shaft. Those prior art elements are provided in a variety of vertically-continuous shapes. For example, the HELIXWIND™ vertical wind turbine models S322 VWAT and S594 VWAT include a pair of segmented solid helical elements. One aspect of the current invention is the use of a plurality of separated horizontally-oriented wind capture elements rather than tall vertical vanes.

There is a need for low-cost and high efficiency vertical-axis turbines for use with water or wind. The current invention addresses that need, with a simple, reliable, and efficient modular device.

### SUMMARY OF INVENTION

The current invention provides vertical axis fluid turbines or fluid turbine modules based on the plurality of fluid capture element layers, where each layer provides a plurality of fluid capture elements. The layers are radially offset, thereby providing a spacing between vertically-adjacent fluid capture elements. This spacing permits fluid to flow around the fluid capture elements that are turning into the direction of fluid flow, thereby reducing back-pressure on the device while maintaining a large fluid capture profile.

The current invention provides a low rpm, high-torque power generation device which may be used to generate electricity, or to provide direct applications such as pumping.

### Layer Configuration

FIG. 1 is a top view of an example layer 300 in one embodiment of the current invention. In this example, there are three fluid capture elements 400a, 400b, and 400c per layer. The fluid capture elements are attached to a rotating shaft 200. The fluid direction 50 is generally left to right, and the layer will rotate about the shaft 200 in a counterclockwise direction. This fluid direction is selected for illustration only, and the fluid may come from any direction.

The term fluid catcher refers to an element designed to intercept either wind or water flow. In another embodiment, there are four fluid capture elements per layer.

Test devices have been constructed with diameters of approximately 8 inches (20 cm) to 16 feet (4.9 m); with fluid capture elements having heights of 1 (2.5 cm) to 8 inches (20 cm). The device design is scalable and larger devices can be constructed. On the other hand, one of the advantages of the device is its relatively low cost, and it may be more economical to space multiple units in an area or on a rooftop rather than to build a single large unit.

The layer spacing, or spacing between adjacent layers is typically about 0.5 to 0.75 inches (1.3 to 1.9 cm), but may be less than or greater than that range.

FIG. 2 is a top view of example layers 400, 401, and 402 in one embodiment of the current invention. In this embodiment, each layer is staggered or offset by approximately 10° from its neighbor layers. For instance, if a first layer element 400a is designated as 0°, the corresponding second layer element 401a has an offset orientation angle a1 of about 10°, and the corresponding third layer element 402a has an offset orientation angle a2 of about 20° etc. In this example, wind capture elements 401b and 402b are offset 10° and 20° from element 401a; and wind capture elements 401c and 402c are offset 10° and 20° from element 401c.

In this example, the layer to layer orientations, such as a1 and a2 are constant. In other examples, the layer offset may be varied. FIG. 2 shows an offset in the direction of rotation as the layer height increases. In other embodiments, this offset may be opposite the direction of rotation. In some examples, the offset angle is positive in the lower layers of the device, and the offset angle is negative in the upper layers of the device. In some examples, the offset angle is negative in the lower layers of the device, and the offset angle is positive in the upper layers of the device.

In another embodiment, each layer is staggered or offset by approximately 7° from its neighbor layers. In tests to date, the offset angle has been 7 to 10 degrees. In other examples, the offset angle could be less than 7 degrees or more than 10 degrees.

Test devices have been constructed so that the device turns in a counterclockwise direction. In other examples, this orientation may be reversed so that the device turns clockwise by rotating the fluid capture elements 180 degrees.

### Fluid Capture Elements

In one embodiment, a plurality of fluid capture elements, each comprising a convex main portion, are attached to the shaft. As described below, the fluid capture element has a profile which is concave with respect to the direction of incoming fluid flow so that it can capture fluid, and has a convex profile against the direction of fluid flow. This concave/convex profile, described as “convex” in this specification, provides a net force in the direction of the fluid flow.

In the examples shown below, this section is shown as horizontal. In other examples, the fluid capture elements may be provided at an angle with respect to the shaft. This main portion of the fluid capture element is designated as the proximal section 410 as illustrated in FIG. 1. In one embodiment, this main portion is one half of a plastic or metal pipe. In another embodiment, the horizontal main portion is an angular section of plastic or metal. In other examples, other cross sections may be provided, and the cross sectional shape may vary along the length of the fluid capture element. One advantage of using angular or half-pipe cross sections is that existing commodity materials, such as PVC pipe or steel angle, may be used in construction in order to provide relatively low-cost fluid capture elements. In other examples, the cross sectional shape may be customized to optimize factors such as weight, cost, wind capture efficiency, and drag.

This convex horizontal portion of the proximal section serves to capture fluid momentum while permitting the element to slice through downwind or down flow fluid with reduced drag, thereby providing a net force in the direction of fluid flow. The horizontal main portion has a first proximal end 412 attached to the vertical shaft 200, and a second distal outward end 414.

The term “convex” in this specification refers to a shape which has a concave opening exposed to the direction of the fluid flow, and a convex surface exposed against the direction of the fluid flow. For instance, the open portion of a half-pipe cross section fluid capture element is concave as shown in FIG. 3A, and will capture fluid, while the closed portion of the half-pipe cross section is convex so that fluid is driven around the outside of the half-pipe cross section as the element is rotated into the direction of fluid flow. The open portion of an angle cross section fluid capture element is concave as shown in FIG. 3B, and will capture fluid, while the closed portion of the angle cross section is convex so that fluid is driven around the outside of the angle cross section as the element is rotated into the direction of fluid flow. Custom shapes such as illustrated by FIG. 3C may other concave/convex profiles.

In some embodiments, prefabricated extruded PVC pipe or angle is used for capture elements and tip elements are attached to the fluid capture elements. In other embodiments, the fluid capture and tip components may be fabricated in a single step, such as by injection molding, and the element shape may be optimized by simulation analysis and testing. As described more fully below, testing to date has been with available materials such as angles and pipes. In high volume production, it may be economical to provide a custom design for the wind capture elements, such as providing a more aerodynamic wing-shape of the cross section, or providing greater wall thickness toward the shaft than on the distal ends of the wind capture elements.

The forces of the individual segments are transferred to the vertical rotating shaft where the energy may be used for electrical power generation or other uses such as direct fluid pumping.

### Tip Capture Elements

In some embodiments of the current invention, a portion of the air pressure or water pressure that would normally be lost by drag in vertical turbines is captured by transferring a portion of the wind or liquid to the tips of the capture elements. In one embodiment, the tip capture elements, termed distal sections 420, are provided comprising short sections of plastic pipe that are affixed to the outward end of the horizontal main portion. Flat angle braces for other reinforcement means may be used to secure the tip capture elements to the horizontal main portion. As fluid engages the concave horizontal main portion, some of the fluid is directed outwardly toward the tip capture elements. As the fluid engages the tip capture elements, additional torque is provided by the device. In other embodiments, a tip capture element may be a simple closure of all or part of the concave cross section of the proximal section of the fluid capture element 410. In other embodiments, a tip capture element may be a simple closure with an extension that projects beyond the concave cross section of the proximal section of the fluid capture element.

In FIG. 1, the main portion of the wind capture elements are (a) shown as horizontal, or orthogonal to the shaft; (c) are shown as a linear elements, and (c) shown as having tip capture elements that shorter linear elements that are orthogonal to the horizontal main portion. In general, the wind capture elements may be attached at an angle with respect to the shaft; and either, or both of, the proximal sections and the distal sections can be non-linear such as illustrated in FIG. 7C. In FIG. 2, the tip capture elements are shown as having an arc shape. In another example, the proximal section 410 may be arced and the distal section 420 may be attached so that its second longitudinal axis 425 is orthogonal to the tangent or first longitudinal axis 415 of the second end 414 of the proximal section 410. In another example, the proximal section may be arced and the distal section may be attached at an acute or obtuse angle with respect to the tangent of the distal end of the distal section. In another example, the proximal sections and the distal sections can be fabricated as a smooth curve. Some example shapes are shown in FIGS. 7A-7C.

### Uses

In one embodiment the turbine is used for generating electricity from wind or water flow. In another embodiment the turbine is used for generating electricity from water such as tidal or stream flow applications.

One aspect of the design is that there are no moving parts to the device other than the rotating capture elements

### DESCRIPTION OF FIGURES

FIG. 1 is a top view of an example layer showing 3 wind capture elements.

FIG. 2 is a top view of three example layers, each having 3 wind capture elements which are offset with respect to adjacent layers.

FIG. 3A is a side view of a hemispherical cross section of a fluid capture element.

FIG. 3B is a side view of an angular cross section of a fluid capture element.

FIG. 3C is a side view of a custom cross section of a fluid capture element.

FIG. 4 is a side view of a partially constructed vertical turbine having four layers of three wind capture elements per layer.

FIG. 5 is a side view of an eleven-layer vertical turbine mounted on a platform.

FIG. 6 is a bottom perspective view of an upper portion the eleven-layer turbine of FIG. 5.

FIG. 7A is a top view of an example fluid capture element shape with a linear proximal section and a linear distal section.

FIG. 7B is a top view of an example fluid capture element shape with a linear proximal section and an arced distal section.

FIG. 7C is a top view of an example fluid capture element shape with an arced proximal section and an arced distal section.

FIG. 8 is a bottom perspective view of a lower portion the eleven-layer turbine of FIG. 5 illustrating a gap between fluid capture elements.

FIG. 9 is a side perspective view of the eleven-layer turbine of FIG. 5 placed in a wind turbine.

FIG. 10 is a side perspective view of a turbine with angular fluid capture elements.

FIG. 11A is a top view of the central portion of a layer module with fluid capture elements affixed to a triangular plate.

FIG. 11B is a side view of two triangular plates with bushings inserted over a shaft.

### DESCRIPTION OF EMBODIMENT

### Eleven Layer, Single Module, Vertical-Axis Wind Turbine with Three Fluid Capture Elements

The following element list is presented for convenience in summarizing the elements shown on the drawings which illustrate embodiments of the current invention.

### ELEMENT LIST

50 fluid direction
55 wind tunnel
70 building, existing structure
72 platform
80 Support frame
90 generator
92 pump
100, 101, 102, 104 module
   110 module frame structure
   200 shaft
      210 lower bearing
      220 upper bearing
   300, 301, 302, 303 fluid capture element layers
      310 mounting plate
         312 sleeve

Fluid Capture Elements
400a, 400b, 400c, 400d fluid capture elements in a first layer
401a, 401b, 401c, 401d fluid capture elements in a second layer
402a, 402b, 402c, 402d fluid capture elements in a third layer
   a1 layer1 to layer2 offset
   a2 layer2 to layer3 offset
      410 proximal section
   412 First end portion
   414 Second end p3 415 first longitudinal axis
   420 distal section
      422 First end portion
      424 Second end
      425 second longitudinal axis
      447, 448 distal section reinforcement elements
   450a, 450b, 450b tip-to-tip reinforcement elements
   480 gap from vertical and spiral offset

This example describes an eleven-layer wind turbine having a height of about 7 feet (2.1 m). This height was selected as the largest practical size for an available wind tunnel as shown in FIG. 9. Commercial versions of this embodiment may be taller—such as about 10-20 feet (3-6 m) per module. As described below, modules may be stacked.

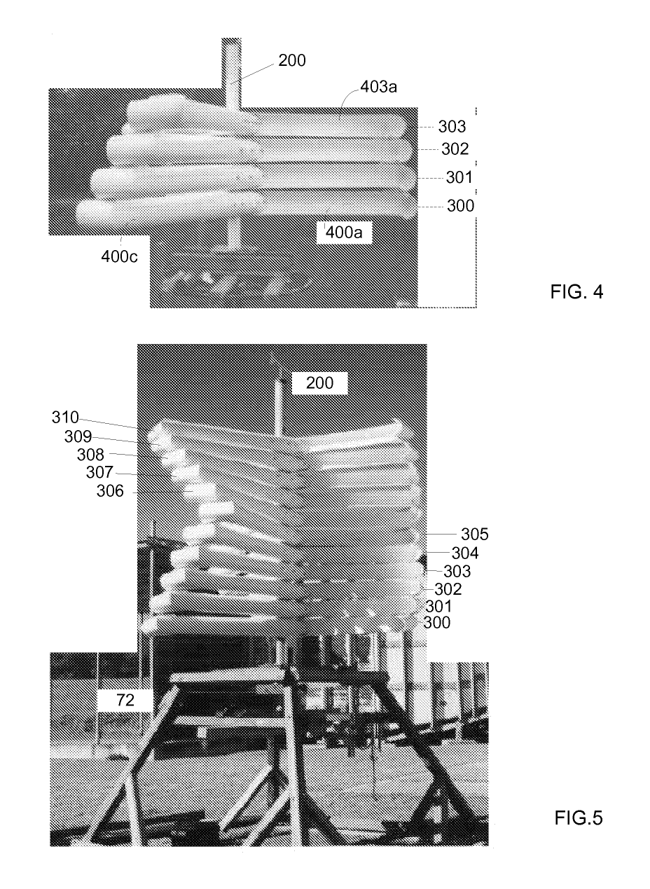

FIG. 4 is a side view of a partially constructed vertical turbine having a shaft 200, and 4 layers 300, 301, 302, and 303, each having four wind capture elements such as elements 400a, 401a, 402a, and 403a.

FIG. 5 is a side view of an 11-layer vertical turbine mounted on a platform 72. In this example, layers 301, 302, 303, 304, and 305, are sequentially offset in the direction of the wind from layer 300; and layers 306, 307, 308, 309, and 310 are sequentially offset in the direction opposite of the wind from layer 305.

In this example, the shaft 200 is supported by a platform 72. In other examples as discussed below, the shaft may be supported by a frame.

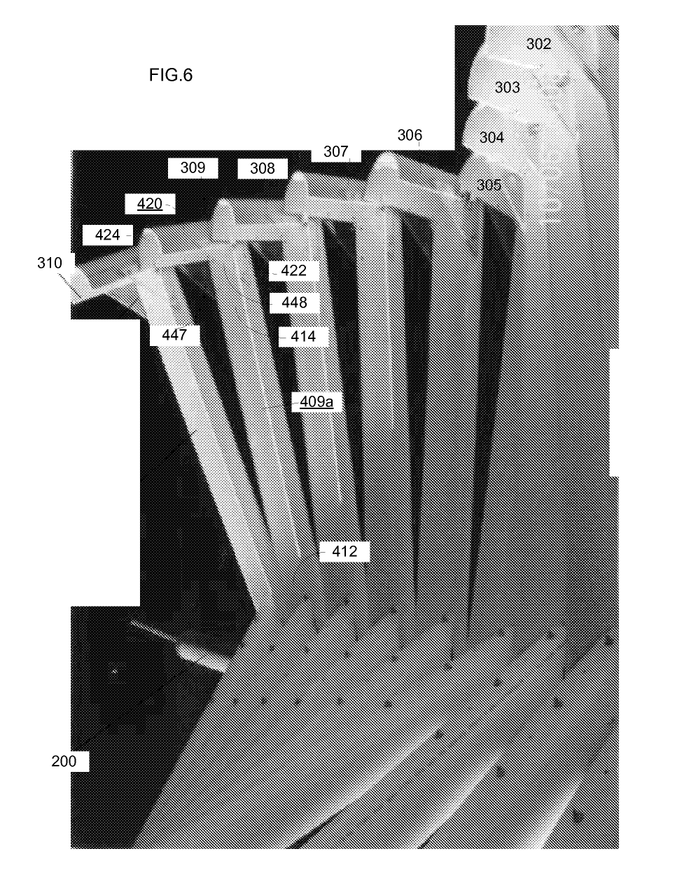

FIG. 6 is a bottom perspective view of an upper portion a the 11-layer turbine of FIG. 5. This view shows portions of layers 301, 302, 303, 304, 305, 306, 307, 308, 309, and 310. Details of a wind capture element 409a on layer 309 are shown, including the proximal section 410 with a first end portion 412 and a second end 414; a distal section 420 with a first end portion 422 and a second end 424, and a pair of distal section reinforcement elements 447 and 448 to reinforce the attachment of the distal section to the proximal section.

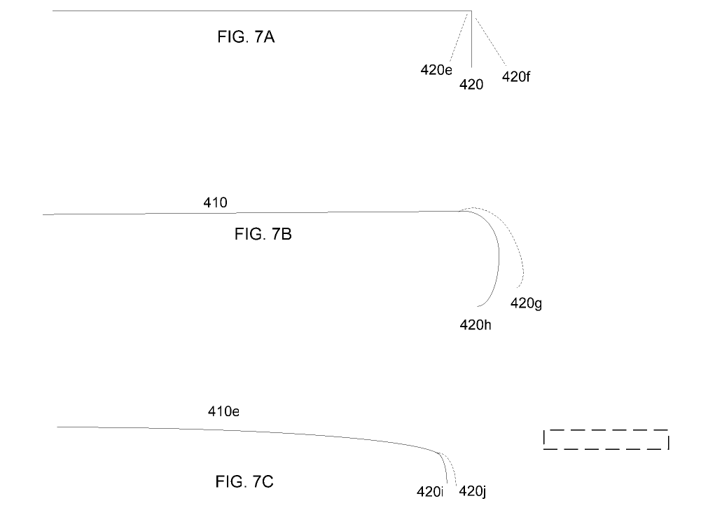

FIG. 7 is a top view of example wind capture element shapes. FIG. 7A shows a straight proximal section 410 with an orthogonal distal section 420 as shown in the example of FIGS. 4-6. FIG. 7A also shows alternative example straight distal section orientations including an acute angle 420e with respect to the proximal section, and an obtuse angle 420f with respect to the proximal section. FIG. 7B shows example curved distal sections 420h and 420g with respect to a straight proximal section 410. FIG. 7C shows a curved proximal section 410e with curved distal sections 420i and 420j.

Preliminary experimentation has indicated that curved surfaces such as the PVC pipe are more efficient than angular surfaces. In another example, a similar design was constructed of plastic angle elements so that the right angle edge of the element cuts through the downwind or downcurrent direction. The curved surfaces of PVC pipe appear to be more efficient and offer less fluid resistance. This cross-section profile may be adjusted as more efficient shapes are identified through wind tunnel testing or computer analysis.

Several examples of this type of PVC pipe embodiment were constructed of readily available and extruded pipe. It is possible that additional testing and analysis will identify shapes that have enough improve efficiency over the pipe to justify injection molding of custom shapes.

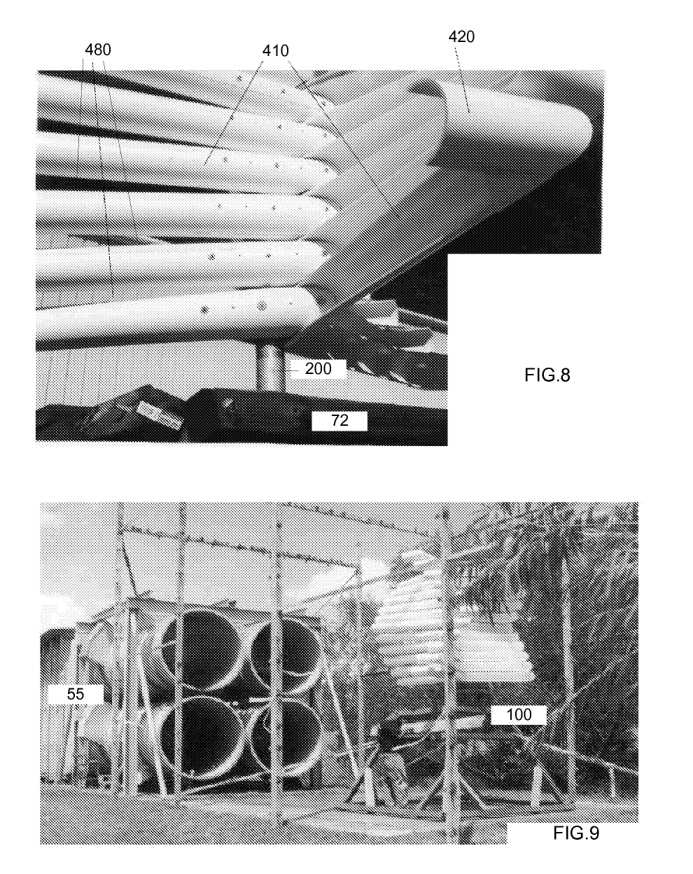

In one example, layer 2 is offset 10° counterclockwise with respect to layer 1, and layer 3 is offset approximately 10° counterclockwise with respect to layer 2, etc., so that the effect of the design is to provide a spiraling of the wind capture elements. This offset provides room for air to travel above and beneath the wind capture element as the element is rotated. FIG. 8 illustrates the gaps 480 between vertically-adjacent fluid capture elements. In this example, the actual vertical separation is 0.5 inches (1.3 cm) between 6 inch (15.2 cm) fluid capture elements, but the gap widens considerably with distance from the shaft because of the angular offset between layers.

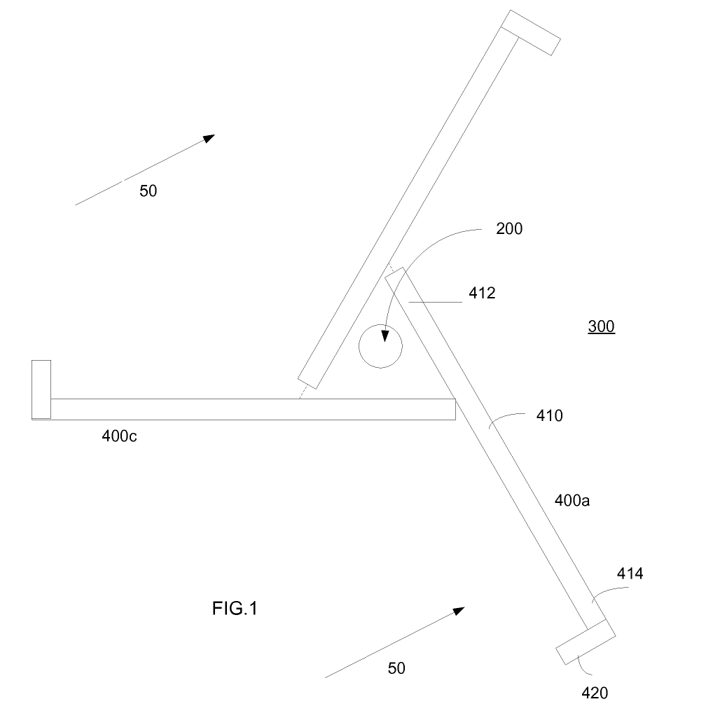

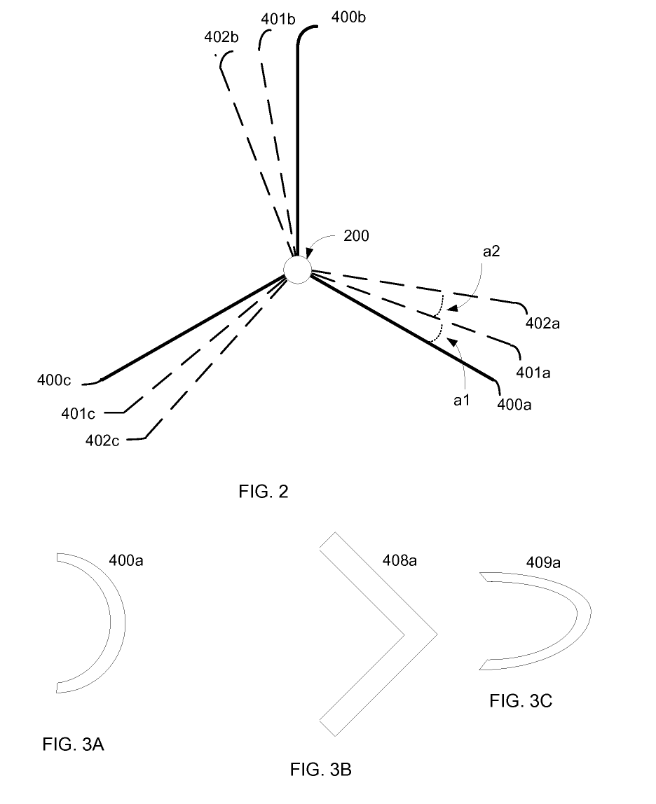

Experimentation has indicated that three elements are more efficient than a four element per layer design. Preliminary results suggest that a four to 12 inch diameter pipe is efficient with capture elements of about 4 to 20 foot arm length. In the example of FIG. 1, an 8 foot diameter device is constructed of six-inch PVC pipe with approximately 4 foot long main sections, distal portion lengths of 12 inches and a ½″ (1.3 cm) vertical gap between layers. This relatively small vertical gap may be used because the spiral offset of the elements provides additional space for fluid flow to reduce drag as the fluid capture element returns against the direction of fluid flow.

Although other materials may be used, the wind capture elements are typically PVC or polycarbonate.

### Fabrication and Assembly

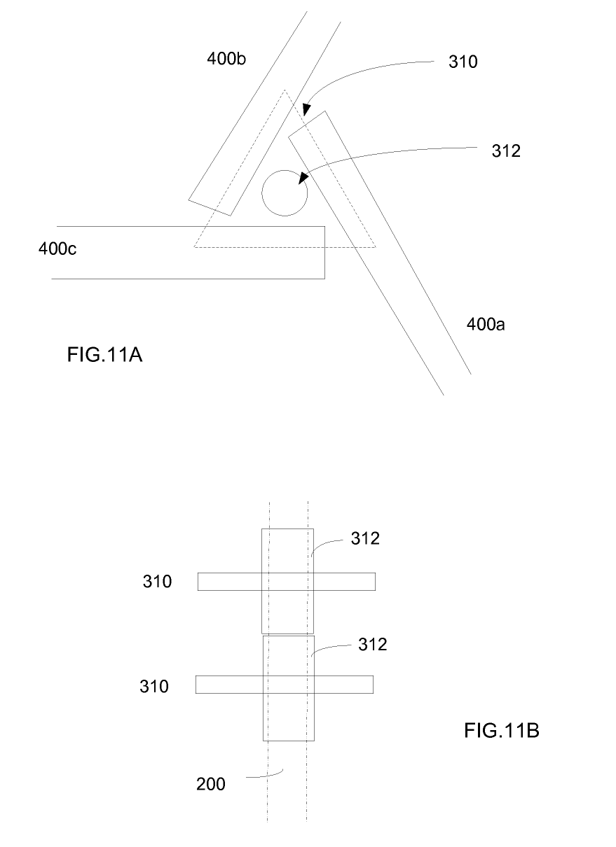

In this example, the turbine is constructed by preparing and assembling individual layer assemblies. For example, FIG. 11A is a top view of the central portion of a layer module in one example method of construction. In this example, a pipe section or bushing 312 is attached to a triangular plate 310. Three fluid capture elements 400a, 400b, 400c, and 400d are bolted to the triangular plate. FIG. 11B is a side view of two triangular plates 310 and bushings 312 inserted over a shaft 200. The fluid capture elements are not shown in this view. The triangular plates are rotated to a desired angular offset and then the bushings are secured to the shaft by set screws (not shown).

A similar construction technique can be provided with a square plate for a 4 fluid element per layer design, and other plate shapes can be used for other configurations.

The tips of the wind capture elements may be connected to each other to provide additional support and bracing.

### Advantages

Advantages of the device include the ability to mount the device on a rooftop because of low noise generation and the ability to space the devices close together. Unlike horizontal axis conventional windmills which rotate to achieve wind orientation, these devices are fixed and can capture wind from any direction. Units may be spaced close together, and guy wires may be used to secure and reinforce the top of the vertical shaft without interfering with the rotation of the wind capture elements. Therefore much less base rigidity is required for the shaft support, and this aspect reduces the cost and the weight of the device.

For offshore applications, the unit may be lowered into a silo for protection against hurricanes. In some applications, the device may be placed in a fast-moving river. Devices are typically used to generate electricity, although other applications such as fluid pumping may be used for direct use of energy.

One feature of the devices is that fluid which contacts the fluid capture elements in the central portion of the device is transferred to the tip to improve torque. The offset capture elements may be further supported by a diagonal braces and the like. The current invention provides turbines with high torque and low tip speed.

The wind capture portion may be elevated on platforms as shown in these figures, or may be located on top of buildings.

### Description of Embodiment

### Vertical-Axis Wind Turbine with Angular Fluid Capture Elements

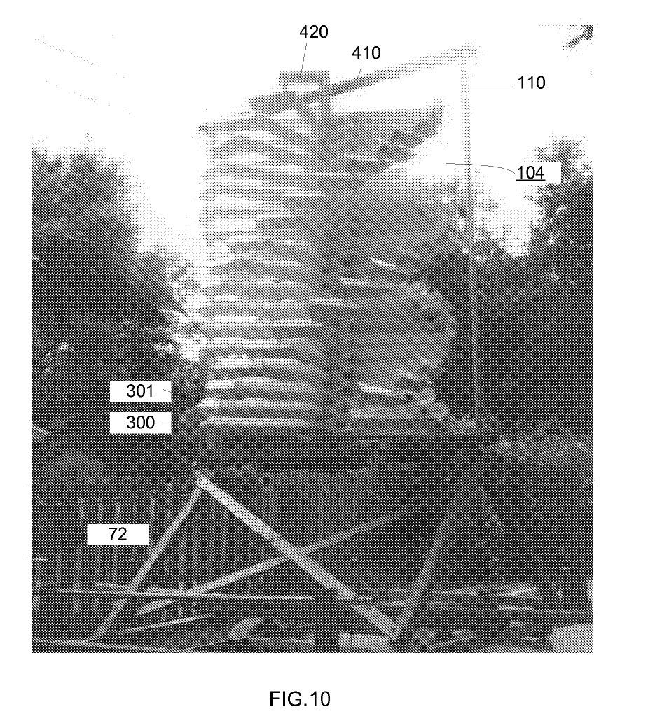

FIG. 10 is a side perspective view of a turbine with angular fluid capture elements. In this example, plastic angle fluid capture elements were oriented so that the right angle edge of the elements cut through the downwind or downcurrent direction. Preliminary testing indicated that these fluid capture elements were less efficient than the half-pipe elements. These results suggest that further improvement in efficiency can be obtained by optimizing the concave/convex cross section to optimize fluid capture versus drag.

### Description of Embodiment

### Turbine Support Frames and Modules

### Frame Structures

FIGS. 4 and 5 show a turbine module frame structure 110 with a single post or shaft 200.

FIG. 10 shows a turbine module frame structure 110 with a two-dimensional rectangular module frame structure 112. This structure can support an upper shaft bushing to reinforce the rotating shaft. Lower bearing supports, or bushings are typically provided for all frame configurations. Guy wires may be used to support the two-dimensional rectangular module frame structure or polygonal module frame structures described below.

In other examples, a polygonal module frame structure may be provided such as a triangular module frame structure where an upper shaft bushing is supported in the middle of the top of the triangular frame structure; or a rectangular module frame structure where an upper shaft bushing is supported in the middle of the top of the rectangular frame structure. Other polygonal frame structures may be provided. In some embodiments, these polygonal frame structures may be stacked and either support separate shafts, or provide a plurality of bushings to support a single long shaft.

### Description of Embodiment

### Other Turbine Examples

### Cross Section Shapes

Experiments have been conducted with available materials such as pipe and angle. FIG. 3A shows a hemispherical cross section created by cutting a PVC or metal pipe in half. FIG. 3B is an angular cross section created with angle material. The shape of the wind capture elements may also be customized in cross section such as shown in FIG. 3C. The shape of the wind capture elements may also be varied over the length of the elements, such as by using molded or cast elements.

Example demonstration units were constructed of 1 inch diameter PVC pipe and 4 inch diameter PVC pipe which were cut in half.

### Description of Embodiment

### Electrical Power Generation

In this embodiment, a wind turbine is provided such as described above, and the rotating shaft power is geared to provide a higher rpm to run an electrical generator.

### Description of Embodiment

### Water Pump

In this embodiment, a wind turbine is provided such as described above, and the rotating shaft power is converted to a reciprocating motion to provide a direct water pump device rather than an electrical generation device.

### Description of Embodiment

### Water Turbine

In this embodiment, a turbine is provided such as described above, and placed in flowing water so that the water is the fluid which drives the turbine rather than wind.
The embodiments described above are provided as examples of embodiments of the current invention, and do not limit the scope of the invention.

What is claimed is:

1. A vertical fluid turbine comprising
a first module (100) comprising
a vertical rotating shaft (200),
a plurality of offset fluid capture element layers (300), each fluid capture element layer comprising
a plurality of radially offset fluid capture elements (400), each fluid capture element comprising
a proximal section (410) having
a convex cross section,
a first end portion (412) affixed to the rotating shaft, and
a second end portion (414) having a first longitudinal axis (415), and
a distal section (420) affixed to the second end portion.

2. The vertical turbine of claim 1 further comprising
a first module frame structure (110) such that the vertical rotating shaft (200) is supported by the first module frame structure.

3. The vertical turbine of claim 1 wherein
the plurality of radially offset fluid capture elements (400), further comprise three fluid capture elements per layer.

4. The vertical turbine of claim 1 wherein each fluid capture element comprises
a distal section (420) having a longitudinal axis (425) which is orthogonal to the first longitudinal axis (415) of the proximal section (410) of the fluid capture element.

5. The vertical turbine of claim 1 wherein each fluid capture element comprises
a distal section (420) having a longitudinal axis (425) which is provided at an obtuse angle with respect to the first longitudinal axis (415) of the proximal section (410) of the wind capture element

6. The vertical turbine of claim 1 wherein
the distal sections (420) comprise reinforcement elements (426, 427).

7. The vertical turbine of claim 1 wherein the first module frame further comprises
an upper shaft bearing (220); and
a lower shaft bearing (210).

8. The vertical turbine of claim 1 wherein
the first module frame is supported by a base selected from the group consisting of ground, building rooftop, and elevated platform.

9. The vertical turbine of claim 2 further comprising
a second module frame (101), supported by the first module frame, the second module frame comprising
a second module frame structure (110),
a vertical rotating shaft (200) supported by the second module frame structure,
a plurality of columns of offset fluid capture element layers (300), each fluid capture element layer comprising
a plurality of radially offset fluid capture elements (400), each fluid capture element comprising
a convex proximal section (410) having
a first end portion (412) affixed to the rotating shaft, and
a second end portion (414) having a first longitudinal axis (415), and
a distal section (420) affixed to the second end portion.

10. The vertical turbine of claim 9 further comprising
a third module frame (102) supported by the second module frame.

11. The vertical turbine of claim 1 further comprising
five to twenty wind capture element layers (300), each wind capture element layer having 3 or 4 wind capture elements, each layer radially offset from adjacent layers by 5 to 15 degrees.

12. The vertical turbine of claim 9 wherein
each wind capture element has a length of 3 to 12 feet.

13. The vertical turbine of claim 1 wherein
the wind capture elements have a cross-sectional shape selected from the group consisting of hemispherical, right angle, and non-symmetric convex.

14. The vertical turbine of claim 1 further comprising
an electrical generator having a shaft turned by the vertical rotating shaft.

15. The vertical turbine of claim 1 further comprising
a fluid pump having a shaft turned by the vertical rotating shaft.

16. A method of generating energy with a vertical turbine, the method comprising providing a vertical turbine comprising
a first module (100) comprising
a vertical rotating shaft (200) supported by the first module frame structure,
a plurality of columns of offset wind capture element layers (300), each fluid capture element layer comprising
a plurality of radially offset wind capture elements (400), each fluid capture element comprising
a convex proximal section (410) having
a first end portion (412) affixed to the rotating shaft, and
a second end portion (414) having a first longitudinal axis (415), and
a distal section (420) affixed to the second end portion;
placing the vertical turbine in a flowing fluid; and
rotating the vertical turbine shaft with the flowing fluid.

17. The method of claim 16 further comprising
driving a fluid pump with the rotating vertical turbine shaft.

18. The method of claim 16 further comprising
driving a generator shaft with the rotating vertical turbine shaft.

19. The method of claim 18 wherein rotating the vertical turbine shaft with a flowing fluid further comprises
rotating the vertical turbine shaft with wind or flowing water.

20. The method of claim 16 further comprising placing the vertical turbine on a rooftop.
